(19) United States
(12) Patent Application Publication
(10) Pub. No.: US 2023/0229522 A1
(43) Pub. Date: Jul. 20, 2023

(54) CONTENT BASED READ CACHE ASSISTED WORKLOAD DEPLOYMENT

(71) Applicant: VMWARE, INC., Palo Alto, CA (US)

(72) Inventors: VIKAS SURYAWANSHI, Bangalore (IN); YOGENDER SOLANKI, Bangalore (IN); SUNEET H. KIRESUR, Bangalore (IN); KUMAR RAGHAVENDRA, Bangalore (IN)

(21) Appl. No.: 17/687,699

(22) Filed: Mar. 7, 2022

(30) Foreign Application Priority Data
Jan. 18, 2022 (IN) 202241002867

(51) Int. Cl. G06F 9/50; G06F 3/06; H04L 9/06

(52) U.S. Cl. CPC G06F 9/5077; G06F 9/5083; G06F 9/5016; G06F 3/0604; G06F 3/064; G06F 3/0664; G06F 3/067; H04L 9/0643

(57) ABSTRACT

In an example, a computer-implemented method for deploying a workload in a virtualized computing environment include retrieving a digest file corresponding to the workload. The digest file may include a plurality of hash values from a storage device and each hash value corresponds to a data block of a plurality of data blocks associated with a virtual disk stored in the storage device. Further, the method includes determining whether the plurality of hash values in the digest file match with data in a CBRC of a destination host computing system and obtaining data blocks corresponding to hash values that are not present in the CBRC from the storage device to store in the destination host computing system. Furthermore, the method includes deploying the workload on the destination host computing system upon obtaining the data blocks corresponding to hash values that are not present in the CBRC.

### RELATED APPLICATION

Benefit is claimed under 35 U.S.C. 119(a)-(d) to Foreign Application Serial No. 202241002867 filed in India entitled “CONTENT BASED READ CACHE ASSISTED WORKLOAD DEPLOYMENT”, on Jan. 18, 2022, by VMware, Inc., which is herein incorporated in its entirety by reference for all purposes.

### TECHNICAL FIELD

The present disclosure relates to computing environments, and more particularly to methods, techniques, and systems for deploying workloads based on a digest file and a content based read cache (CBRC).

### BACKGROUND

OVA (open virtual appliance) template file is a single archive file in TAR file format that contains files for portability and deployment of virtualization appliances (e.g., virtual machines (VMs), virtual applications, or the like). An OVA template file may include an OVF (open virtual format) descriptor file, optional manifest and certificate files, optional disk images (such as VMware vmdk files), optional resource files (such as ISO's) and other supporting files, such as a message bundle file. The OVF lies in a repository/storage device in a compressed and sparse format, allowing for faster downloads. Because of the OVF format, exchange of virtualization appliances across products and platforms can be possible.

Deployment of VMs using the OVF is similar to deploying VMs from a template, however the OVF can be deployed from any filesystem accessible from a client device (e.g., vSphere Client machine), such as CDs, Universal Serial Bus (USB), shared network drives, or remote web servers. In order to deploy a VM from an OVA template file, the files of the OVA template file, such as OVF descriptor, vmdk, manifest, certificate, and message bundle files, must be retrieved from the OVA template file at different stages of a deployment process, so that the OVA template file can be validated, and any needed file is transferred to the destination host computer on which the VM is to be deployed. Thus, if the OVA template file is located at a remote storage location, the entire OVA template file may first have to be downloaded and the files in the OVA template extracted before the extracted files can be used for deployment. Since the OVA template file is typically a large file, this approach would require a significant amount of network transfer time and thus makes the OVF deployment a time-consuming process.

### BRIEF DESCRIPTION OF THE DRAWINGS

FIG. 1A is a block diagram of an example system, depicting a management node to deploy a workload on a destination host computing system in a computing environment based on a content based read cache (CBRC);

FIG. 1B is a block diagram of the example system of FIG. 1A, illustrating a VM being deployed from an OVA template file stored on a web server using the CBRC at the destination host computing system;

FIG. 2 depicts an example digest file, including a plurality of hash values corresponding to data blocks in a VMDK;

FIG. 3 is a flow diagram, illustrating an example computer-implemented method for deploying a workload in a virtualized computing environment using a digest file and a CBRC;

FIG. 4 is another example flow diagram, illustrating an example computer-implemented method for deploying a workload in a virtualized computing environment using a digest file and a CBRC; and

FIG. 5 is a block diagram of an example destination host computing system including non-transitory computer-readable storage medium storing instructions to deploy a workload on a destination host computing system.

The drawings described herein are for illustration purposes and are not intended to limit the scope of the present subject matter in any way.

### DETAILED DESCRIPTION

Examples described herein may provide an enhanced computer-based and/or network-based method, technique, and system to deploy a workload on a destination host computing system in a computing environment based on a content based read cache (CBRC). Computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers executing different computing-instances or workloads (e.g., virtual machines (VMs), virtual appliances, template, and the like). The workloads may execute different types of applications.

In such a virtualized environment, virtual desktops may be provided as part of a virtual desktop infrastructure (VDI) or desktop-as-a-service (DAAS) offerings. A virtual desktop may be an interface available to an individual user in the virtualized environment. The virtual desktop is provided using a workload. Further, an experience of using desktop virtualization may be interpreted by users based on the responsiveness of the virtual desktop. In some examples, the responsiveness of the virtual desktops may be affected by multiple factors such as downloading an OVA template file from a remote storage device to a destination host computing system on which the workload is to be deployed. Since the OVA template file is typically a large file, this approach would require a significant amount of network transfer time and thus the OVF deployment is a time-consuming process. Also, a boot-up time of the workload may be increased.

Examples described herein provides a management node to receive a request to deploy a workload on a destination host computing system. In response to receiving the request, the management node may retrieve a digest file associated with a virtualized computing instance file corresponding to a virtual disk of the workload. The digest file may include a plurality of hash values with each hash value corresponding to a data block of a plurality of data blocks in the virtualized computing instance file. Further, the management node may determine whether the plurality of hash values in the digest file match with data in a CBRC of the destination host computing system. Furthermore, the management node may request data blocks corresponding to hash values that does not exist in the CBRC from the storage device. Also, the management node may deploy the workload on the destination host computing system upon receiving the data blocks corresponding to the hash values that does not exist in the CBRC.

Thus, examples described herein may utilize the digest file and the CBRC at the destination host computing system to reduce the delay in deployment of the workloads using OVF. When the digest file is associated with a OVF file, before getting the OVF file deployed/transferred across wire, the digest file which is small in size is initially transferred and check whether the content of the digest file is already present in the CBRC. Further, logical block numbers (LBNs) which are not present in the CBRC at the destination host computing system, where the workload is deployed, may be requested from the OVF file. Thus, examples described herein may reduce the network transfer time and also reduce or avoid delay in booting-up the deployed workload.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

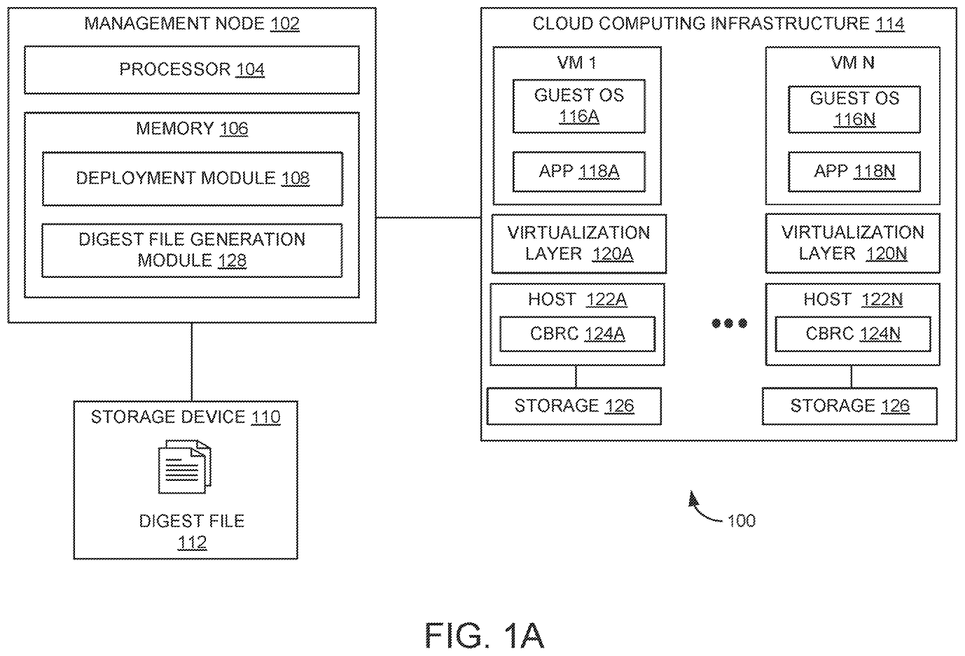

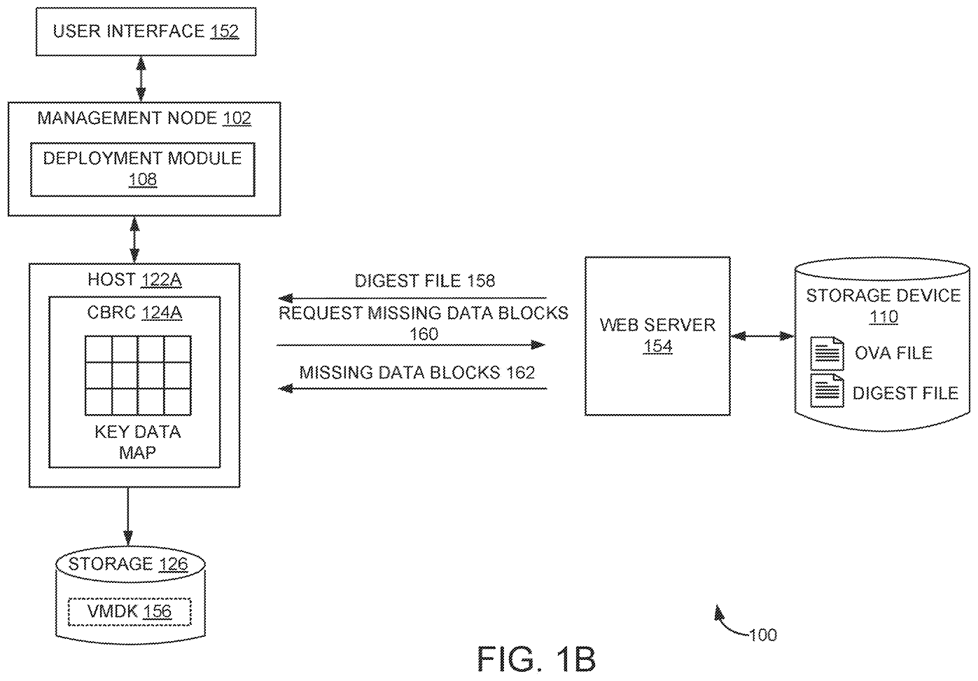

FIG. 1A is a block diagram of an example system 100, depicting a management node 102 to deploy a workload (e.g., VM 1) on a destination host computing system (e.g., host 122A) in a computing environment based on content based read cache (CBRC) 124A. Example system 100 includes a computing environment such as a cloud computing environment (e.g., a virtualized cloud computing environment). An example cloud computing environment is VMware vSphere®. The cloud computing environment may include one or more computing platforms that support the creation, deployment, and management of virtual machine-based cloud applications. One such platform is vRealize Automation, which is commercially available from VMware. While vRealize Automation is one example of a cloud deployment platform, it should be noted that any computing platform that supports the creation and deployment of virtualized cloud applications is within the scope of the present embodiment.

As shown in FIG. 1A, system 100 includes multiple host computing systems 122A-122N in a cloud computing infrastructure 114, and management node 102 connected to host computing systems 122A-122N. Host computing systems 122A-122N are physical computer systems that are used to support or host multiple workloads (e.g., virtual computing instances VM 1-VM N) that can execute various applications 118A-118N. As used herein, the term “workload” refers to any software entity that can run on a computer system, such as a software application, a virtual machine (VM), a virtual appliance, and a “container” that provides system-level process isolation, e.g., a Docker container. Host computing systems 122A-122N may be servers that are commonly found in data centers. As an example, host computing systems 122A-122N may be servers installed in one or more server racks. Host computing systems 122A-122N can be connected to a network, and thus may be able to communicate with any component or process connected to the network.

As shown in FIG. 1A, each computing system 122A-122N is connected to a storage 126, which is used to store any data for that host computing system, including OVA (open virtual appliance) template files for deployed workloads. Each storage 126 may include one or more computer data storage devices, which can be any type of storage devices, such as solid-state devices (SSDs), hard disks or a combination of both. Storage 126 may be a local storage device of host computing systems 122A-122N, e.g., locally attached disks or SSDs within the host computing systems 122A-122N. In some examples, the storage 126 of host computing systems 122A-122N may be part of a storage system, such a network-attached storage (NAS) and/or a storage area network (SAN). Each storage 126 may support multiple datastores, which are virtualized representations of storage facilities. Thus, each datastore may use the storage resource from more than one storage device included in the storages. The datastores are used to store data associated with the workloads supported by host computing systems 122A-122N.

Each host computing system 122A-122N is configured to support a number of workloads, which are VMs (e.g., VM 1-VM N) in this example. The VMs share at least some of the hardware resources of host computing systems 122A-122N, which include system memory, processors, a storage interface, and a network interface. An example system memory may be random access memory (RAM), which is the primary memory of host computing systems 122A-122N. The processor can be any type of a processor, such as a central processing unit (CPU) commonly found in a server. The storage interface may be an interface that allows host computing systems 122A-122N to communicate with storage 126 that is accessible by host computing systems 122A-122N. As an example, the storage interface may be a host bus adapter or a network file system interface. The network interface may be an interface that allows host computing systems 122A-122N to communicate with other devices connected to the network. As an example, the network interface may be a network adapter.

In the example shown in FIG. 1A, VMs (e.g., VM 1-VM N) run on top of virtualization layers 120A-120N (e.g., Hypervisors), which are software interface layers that enable sharing of the hardware resources of respective one of host computing systems 122A-122N by the VMs. However, in other examples, one or more of the VMs can be nested, i.e., a VM running in another VM. Any computer virtualization architecture can be implemented. For example, the hypervisor may run on top of the host computing system's operating system or directly on hardware of host computing systems 122A-122N. With the support of a hypervisors, the VMs running on a host computing system (e.g., 122A) provide virtualized computer systems that give the appearance of being distinct from host computing system 122A and from each other. Each VM (e.g., VM 1-VM N) includes a guest operating system (OS) (e.g., 116A-116N) and one or more guest applications (e.g., 118A-118N). For example, guest operating system 116A manages virtual system resources made available to VM 1 by virtualization layer 120A, and, among other things, guest operating system 116A forms a software platform on top of which guest application 118A runs.

Similar to any other computing system connected to the network, VM 1-VM N are able to communicate with other computer systems connected to the network using the network interface of respective host computing systems 122A-122N. In addition, VM 1-VM N are able to access storage 126 accessible by host computing systems 122A-122N using the storage interface of respective host computing systems 122A-122N.

Further, management node 102 may operate to monitor and manage host computing systems 122A-122N. In an example, management node 102 may monitor the current configurations of host computing systems 122A-122N and the workloads, e.g., VMs, running on host computing systems 122A-122N. The monitored configurations may include hardware configuration of each of host computing systems 122A-122N, such as CPU type and memory size, and/or software configurations of each of host computing systems 122A-122N, such as operating system (OS) type and installed applications or software programs. The monitored configurations may also include workload hosting information, i.e., which workloads are hosted or running on which host computing systems 122A-122N. The monitored configurations may also include workload information. The workload information may include size of each of workloads, virtualized hardware configuration of each of the workloads, such as virtual CPU type and virtual memory size, software configuration of each of the workloads, such as OS type and installed applications or software programs running on each of the workloads, and virtual storage size for each of the workloads. The workload information may also include resource parameter settings, such as demand, limit, reservation and share values for various resources, e.g., CPU, memory, network bandwidth and storage, which are consumed by the workloads. The “demand,” or current usage, of the workloads for the consumable resources, such as CPU, memory, network, and storage, are measured by host computing systems 122A-122N hosting the workloads and provided to management node 102.

Management node 102 may also perform operations to manage the workloads VM 1 to VM N and host computing systems 122A-122N. Management node 102 may perform various resource management operations for the cluster, including migration of workloads between host computing systems 122A-122N in the cluster for load balancing. Management node 102 may also be configured to manage deployment of workloads in any of host computing systems 122A-122N using templates, such as OVA files, as explained below.

In an example, management node 102 includes a processor 104 and a memory 106 coupled to processor 104. In other examples, management node 102 may be implemented as software program running on a physical computer, such as host computing system 122A, or a virtual computer, such as VM 1. Example management node 102 may be a VMware® vCenter™ server with at least some of the features available for such server. Memory 106 may include a deployment module 108 and a digest file generation module 128. Deployment module 108 may perform various deployment-related operations so that workloads can be deployed on host computing systems 122A-122N using OVA template files on web servers (e.g., storage device 110), without having to download and store the entire OVA file from storage device 110.

During operation, digest file generation module 128 may divide a virtual disk into a plurality of data blocks having an n-word block size. An example virtual disk may be a virtual machine disk file (VMDK). The VMDK may store contents of the workload's (e.g., VM 1's) hard disk drive. Further, digest file generation module 128 may determine a hash value corresponding to each data block using a secure hash algorithm (SHA). Furthermore, digest file generation module 128 may generate a digest file112 including mapping of each data block to the corresponding hash value. The digest file can be generated for workload's VMDK. The digest file may include hash values for blocks in the VMDK and a key (e.g., name) corresponding to each hash value.

During operation, deployment module 108 may receive a request to deploy a workload (e.g., VM 1) on destination host computing system 122A. The workload may include a virtual machine (e.g., VM 1), a virtual appliance, or a virtual application. In another example, the workload may be a virtual desktop infrastructure (VDI). The VDI is a virtualization technology that hosts a desktop operating system on a centralized server in a data center.

In response to receiving the request, deployment module 108 may retrieve from storage device 110 (e.g., a web server), digest file 112 corresponding to the workload VM 1 (e.g., to be deployed). Digest file 112 may include the plurality of hash values with each hash value corresponding to a data block of the plurality of data blocks associated with the virtual disk stored in storage device 110. In an example, storage device 110 is an open virtualization format (OVF) repository locally accessible to destination host computing system 122A or remotely accessible to destination host computing system 122A via a uniform resource locator (URL).

Further, deployment module 108 may determine whether the plurality of hash values in digest file 122 match with data in CBRC 124A of destination host computing system 122A. For example, CBRC 124A is a random-access memory based read cache that helps multiple workloads with identical memory contents, based on granularity chosen while creating digest file 122, to use the physical host RAM effectively, by sharing the identical memory pages (referred to herein as “pages”) across multiple workloads. When CBRC 124A is enabled on the virtual disk, CBRC 124A may build an on-disk hash called a digest file. The digest file may provide a signature of the contents of the memory. For example, CBRC 124A first references the digest file and compares the hash with the in-memory cache. If a page with the content is already present in the memory, CBRC 124A returns the same to the workload.

Furthermore, deployment module 108 may transmit data blocks corresponding to hash values that are not present in CBRC 124A from storage device 110 to destination host computing system 122A. In an example, deployment module 108 may, for each hash value, transmit a data block corresponding to a hash value from storage device 110 to destination host computing system 122A in responsive to a determination that the hash value in digest file 112 does not exists in CBRC 124A of destination host computing system 122A. In another example, deployment module 108 may, for each hash value, mark the data block corresponding to the hash value as available and refrain from transmitting the data block corresponding to the hash value to destination host computing system 122A in responsive to a determination that the hash value in digest file 112 exists in CBRC 124A of destination host computing system 122A.

Further, deployment module 108 may initiate deployment of workload VM 1 on destination host computing system 122A in response to transmitting the data blocks corresponding to the hash values that are not present in CBRC 124A. Thus, examples described herein may utilize a digest file which is small in size and check if content of the digest file is already present in a CBRC at a destination host computing system, and only request data from the OVF file which is not there in the destination host computing system (e.g., difference of content between the OVA file and the CBRC can be transferred), thereby reducing or avoiding the transfer of the OVA file and also reducing the delay in boot-up of the deployed workload. Further, examples described herein may utilize online caching and offline hashing mechanism to reduce input/output operations per second (IOPS), reduce network latency, and improve performance during booting of the workload.

FIG. 1B is a block diagram of example system 100 of FIG. 1A, illustrating a VM being deployed from an OVA template file stored on a web server 154 using CBRC 124A at destination host computing system 122A. Similarly named elements of FIG. 1B may be similar in structure and/or function to elements described in FIG. 1A. The OVA template file is stored on web server 154 in storage device 110 and the VM is being deployed on host computing system 122A.

System 100 may include a user interface 152 for management node 102 to transmit a request for a VM deployment from OVA file to deployment module 108 in response to user inputs to initiate the VM deployment. The VM deployment request may include a Uniform Resource Locator (URL) for the OVA template file and may also include the name or identification of the destination host computing system 122A on which the VM is to be deployed.

Upon receiving the deployment request, deployment module 108 establishes a connection with web server 154 using the URL and reads the digest file from storage device 110 (e.g., at 158). The digest file is a crypto-hash representation of the VMDK. For example, the digest file can be created by dividing the VMDK into 4K word size blocks. For each 4k word size block, a corresponding key of that block may be determined, for instance, using a secure hash algorithm (e.g., SHA-1). Further, the data in the VMDK is mapped to corresponding keys block by block in the digest file. The creation of the digest file may be performed during a power off state of the VM. After the digest file is created successfully in the powered off state, the same VM is then powered on to make use of CBRC 124A. An OVF VM when getting deployed, is also be deployed with the digest file, or a VM before getting converted to template/OVF will be placed with the digest file along with other necessary files (e.g., OVA files) of templates/OVFs.

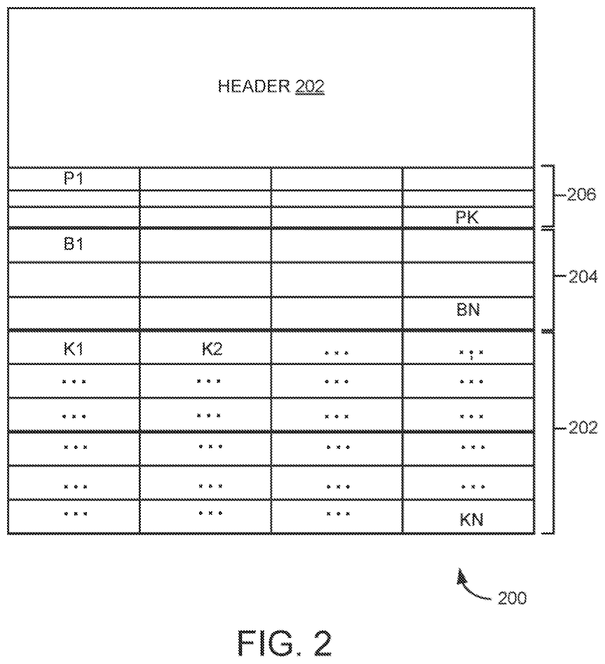

An example digest file 200 is shown in FIG. 2. As shown in FIG. 2, digest file 200 may include a key section 202 having a plurality of hash values (e.g., keys K1 to KN) corresponding to data blocks B1 to BN in the VMDK. Further, digest file 200 may include a first bitmap section 204 having a bit corresponding to each hash value of the plurality of hash values (i.e., keys K1 to KN). Further, each of the bits (e.g., B1 to BN) in the bitmap may indicate a validity of the data in a corresponding one of data blocks B1 to BN of the VMDK. Similarly, digest file 200 may also include a second bitmap section 206 having a bit corresponding to a set of bits in first bitmap section 204. The second bitmap section 206 can be configurable. In the example shown in FIG. 2, first bitmap section 204 may include bits B1 to BN and second bitmap section 206 includes bits P1 to PK, such that K is less than N.

Referring to FIG. 1 B, upon reading the digest file, deployment module 108 may enable host computing system 122A to compare the digest file to content of CBRC 124A. For example, a hash value in the digest file may be compared to hash values (e.g., key-data mapping information) in CBRC 124A. If a match is found, the data block corresponding to the hash value is marked as available. If a match is not found, destination host computing system 122A requests the data block corresponding to the hash value that is not found in CBRC 124A (e.g., at 160). Further, web server 154 may transmit the requested data block corresponding to the hash value that is not found in CBRC 124A to destination host computing system 122A (e.g., at 162). Thus, referencing the digest file against CBRC 124A ensures that duplicate data is not being transmitted from web server 154 to destination host computing system 122A for deployment of the VM. Upon obtaining data blocks for all missing data blocks from web server 154, reference of the digest file may be updated to the corresponding content in CBRC 124A (e.g., a VMDK 156 for VM1 may be created in storage 126 using both the data blocks available in the CBRC and the missing data blocks received from web server 154).

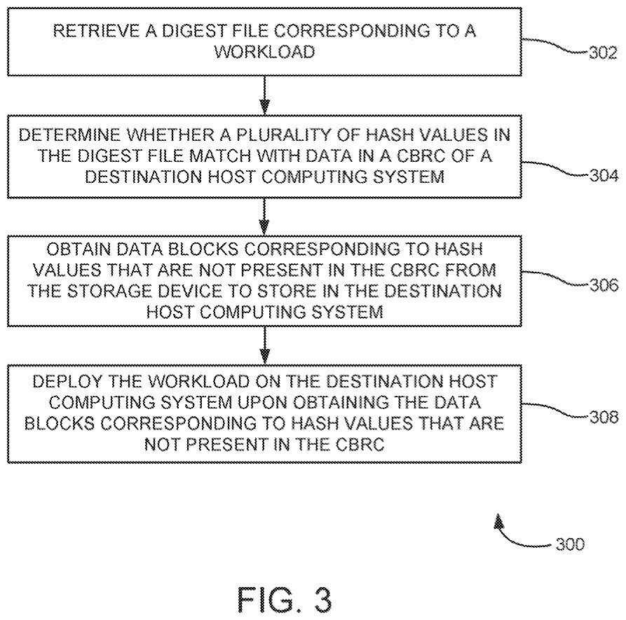

FIG. 3 is a flow diagram 300, illustrating an example computer-implemented method for deploying a workload in a virtualized computing environment using a digest file and a CBRC. In an example, a digest file corresponding to a virtual disk (e.g., of the workload to be deployed) may be generated. The virtual disk may refer to a file (or a set of files) on a host computing system that appears as a physical disk drive to the guest operating system. Virtual disk files store information such as the operating system, program files, and data files and have a “.vmdk” extension. A virtual disk can be a virtual machine disk file (VMDK). The digest file may be a crypto-hash representation of the virtual disk of the workload to be deployed. In an example, the digest file may be generated by:
dividing the virtual disk into a plurality of data blocks having an n-word block size. In an example, the plurality of data blocks relates to the workload is an open virtualization format (OVF) package or open virtualization appliance (OVA) file that packages the workload for deployment.
determining a hash value corresponding to each data block. In an example, the hash value corresponding to each data block can be determined using a secure hash algorithm (SHA).
generating the digest file including mapping of each data block to the corresponding hash value.

Further, a bitmap having a bit corresponding to each hash value of the plurality of hash values may be generated. Further, each bit in the bitmap may indicate a validity of the data in a corresponding data block of the virtual disk. Furthermore, the digest file may be stored in the storage device. The storage device can be an open virtualization format (OVF) repository locally accessible to the destination host computing system or remotely accessible to the destination host computing system via a uniform resource locator (URL).

At 302, the digest file corresponding to the workload may be retrieved. In an example, the digest file includes a plurality of hash values from a storage device and each hash value corresponds to a data block of a plurality of data blocks associated with the virtual disk stored in the storage device.

At 304, a check may be made to determine whether the plurality of hash values in the digest file match with data in a CBRC of a destination host computing system. At 306, data blocks corresponding to hash values that are not present in the CBRC may be obtained from the storage device to store in the destination host computing system (e.g., to store in the CBRC). In an example, for each hash value, a data block corresponding to the hash value is obtained to the destination host computing system in responsive to a determination that a hash value in the digest file does not exists in the CBRC of the destination host computing system. For example, obtaining the data blocks corresponding to the hash values that are not present in the CBRC include:
transmitting, by the destination host computing system, a request to send the data blocks corresponding to the hash values that are not present in the CBRC to the storage device, and
receiving, by the destination host computing system, the data blocks corresponding to the hash values that are not present in the CBRC from the storage device.

In another example, for each hash value, the data block corresponding to the hash value is marked as available and the data block corresponding to the hash value is refrained from obtaining from the storage device in responsive to a determination that the hash value in the digest file exists in the CBRC of the destination host computing system.

At 308, the workload may be deployed on the destination host computing system upon obtaining the data blocks corresponding to hash values that are not present in the CBRC. In this example, the workload may be deployed using the obtained data blocks and the data blocks that are marked as available. In an example, deploying the workload in the destination host computing system includes initial placement of the workload on the destination host computing system. In another example, deploying the workload in the destination host computing system includes placing the workload in the destination host computing system while powering on the workload on the destination host computing system. In yet another example, deploying the workload in the destination host computing system includes placing the workload in the destination host computing system during migration of the workload from a source host computing system to the destination host computing system. In another example, deploying the workload in the destination host computing system includes placing the workload on the destination host computing system during cloning of the workload.

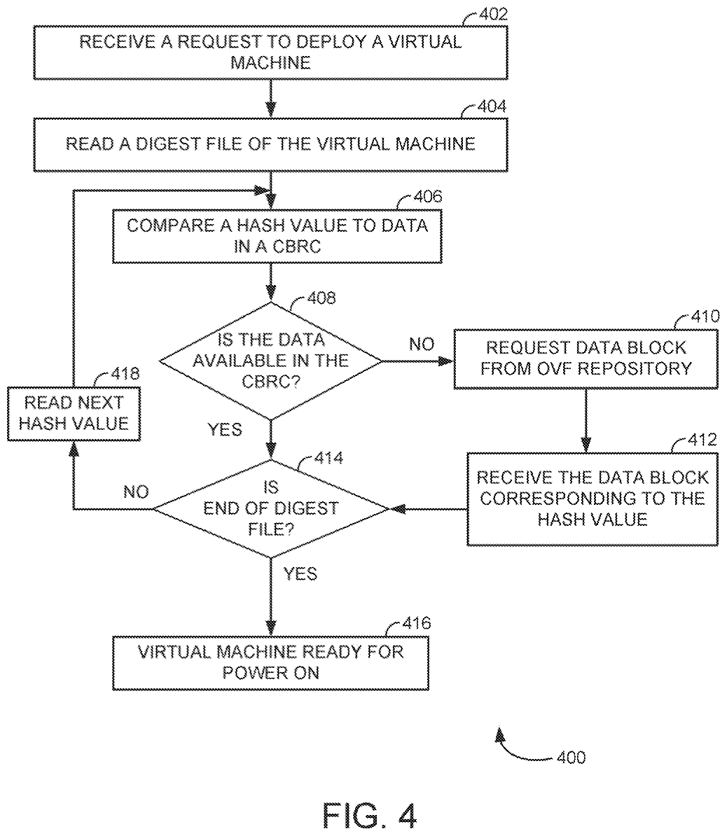

FIG. 4 is an example flow diagram 400, illustrating an example computer-implemented method for deploying a workload in a virtualized computing environment using a digest file and a CBRC. At 402, a request to deploy a VM may be received. At 404, a digest file corresponding to the VM may be read from a storage device (e.g., an OVF repository) upon receiving the request. In an example, the digest file includes a plurality of hash values for a plurality of data blocks in a virtual disk

At 406, a first hash value of the plurality of hash values may be compared with data in the CBRC. At 408, a check may be made to determine whether the data for the first hash value is available in the CBRC. When the data for the first hash value is not available, a request to send data block corresponding to the first hash value may be sent to the OVF repository, at 410. At 412, the data block corresponding to the first hash value may be received from the OVF repository using a logical block number (LBN) of the first hash value.

When the data for the first hash value is available or upon receiving the data block corresponding to the first hash value, a check is made to determine whether each of the hash values is compared with data in the CBRC (i.e., end of digest file condition), at 414. At 418, a second hash value of the plurality of hash values may be selected and the processes 408, 408, 410, 412, and 414 are repeated until all the hash values in the digest file are compared with data in the CBRC.

At 416, upon receiving data blocks corresponding to hash values that are not present in the CBRC, the VM may be deployed on the destination host computing system. In this example, the VM is ready for power on or to perform other operations.

The processes depicted in FIGS. 3 and 4 represent generalized illustrations, and other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate computer-readable instructions, or use a combination of hardware and computer-readable instructions to perform the illustrated processes.

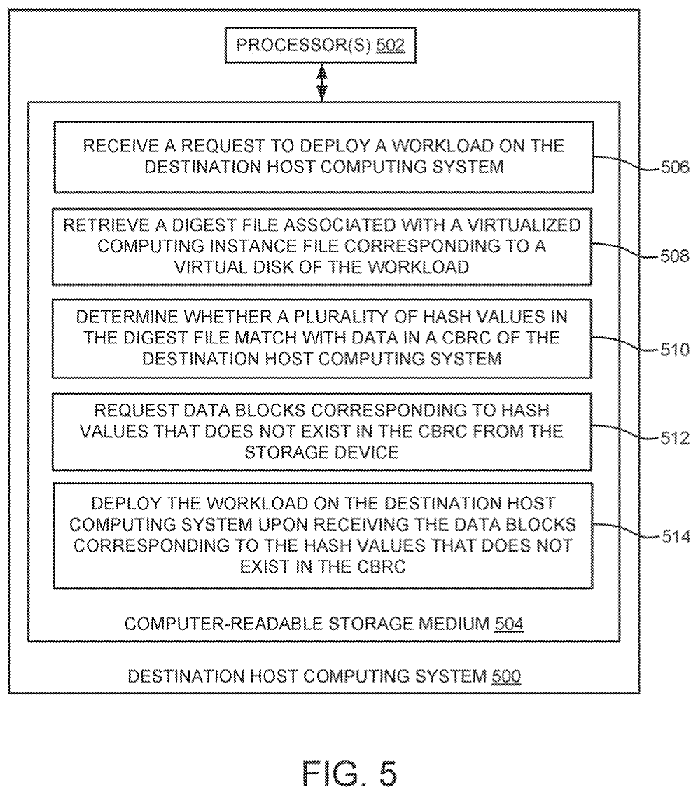

FIG. 5 is a block diagram of an example destination host computing system 500 including non-transitory computer-readable storage medium 504 storing instructions to deploy a workload on a destination host computing system. Destination host computing system 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to destination host computing system 500.

Computer-readable storage medium 504 may store instructions 506, 508, 510, 512, and 514. Instructions 506 may be executed by processor 502 to receive a request to deploy the workload on destination host computing system 500. Instructions 508 may be executed by processor 502 to retrieve a digest file associated with a virtualized computing instance file corresponding to a virtual disk of the workload in response to receiving the request. The digest file may include a plurality of hash values with each hash value corresponding to a data block of a plurality of data blocks in the virtualized computing instance file. Further, the plurality of data blocks relating to the workload may be an open virtualization format (OVF) package or open virtualization appliance (OVA) file that packages the workload for deployment.

Instructions 510 may be executed by processor 502 to determine whether the plurality of hash values in the digest file match with data in a CBRC of destination host computing system 500. Instructions 512 may be executed by processor 502 to request data blocks corresponding to hash values that does not exist in the CBRC from the storage device. In an example, instructions 512 to request the data blocks corresponding to the hash values that does not exist in the CBRC include instructions to, for each hash value, obtain a data block corresponding to the hash value from the storage device in responsive to a determination that a hash value in the digest file does not exists in the CBRC at the destination host computing system. In another example, for each hash value, the data block corresponding to the hash value is marked as available and the data block corresponding to the hash value may be refrained from transmitting to destination host computing system 500 in responsive to a determination that the hash value in the digest file exists in the CBRC of destination host computing system 500.

Instructions 514 may be executed by processor 502 to deploy the workload on destination host computing system 500 upon receiving the data blocks corresponding to the hash values that does not exist in the CBRC. In an example, instructions 514 to deploy the workload on destination host computing system 500 include instructions to migrate or clone the workload running on a source host computing system to destination host computing system 500. In this example, the digest file may include the hash values of the CBRC of the source host computing system when the request is to migrate or clone the workload.

Some or all of the system components and/or data structures may also be stored as contents (e.g., as executable or other computer-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computer-implemented method for deploying a workload in a virtualized computing environment, comprising:
retrieving a digest file corresponding to the workload, the digest file including a plurality of hash values from a storage device, each hash value corresponds to a data block of a plurality of data blocks associated with a virtual disk stored in the storage device;
determining whether the plurality of hash values in the digest file match with data in a content based read cache (CBRC) of a destination host computing system;
obtaining data blocks corresponding to hash values that are not present in the CBRC from the storage device to store in the destination host computing system; and
deploying the workload on the destination host computing system upon obtaining the data blocks corresponding to hash values that are not present in the CBRC.

2. The computer-implemented method of claim 1, wherein obtaining the data blocks corresponding to the hash values that are not present in the CBRC from the storage device comprises:
for each hash value:
responsive to a determination that a hash value in the digest file does not exists in the CBRC of the destination host computing system, obtaining a data block corresponding to the hash value to the destination host computing system; and
responsive to a determination that the hash value in the digest file exists in the CBRC of the destination host computing system, marking the data block corresponding to the hash value a
s available and refraining from obtaining the data block corresponding to the hash value.

3. The computer-implemented method of claim 1, wherein the storage device is an open virtualization format (OVF) repository locally accessible to the destination host computing system or remotely accessible to the destination host computing system via a uniform resource locator (URL).

4. The computer-implemented method of claim 1, wherein the virtual disk is a virtual machine disk file (VMDK).

5. The computer-implemented method of claim 1, further comprising:
generating the digest file corresponding to the virtual disk, the digest file is a crypto-hash representation of the virtual disk of the workload to be deployed; and
storing the digest file in the storage device.

6. The computer-implemented method of claim 5, wherein generating the digest file comprising:
dividing the virtual disk into the plurality of data blocks having an n-word block size;
determining a hash value corresponding to each data block; and
generating the digest file including mapping of each data block to the corresponding hash value.

7. The computer-implemented of claim 6, wherein determining the hash value comprises:
determining the hash value corresponding to each data block using a secure hash algorithm (SHA).

8. The computer-implemented method of claim 5, further comprising:
generating a bitmap having a bit corresponding to each hash value of the plurality of hash values, wherein each bit in the bitmap indicates a validity of the data in a corresponding data block of the virtual disk.

9. The computer-implemented method of claim 1, wherein obtaining the data blocks corresponding to the hash values that are not present in the CBRC comprises:
transmitting, by the destination host computing system, a request to send the data blocks corresponding to the hash values that are not present in the CBRC to the storage device; and
receiving, by the destination host computing system, the data blocks corresponding to the hash values that are not present in the CBRC from the storage device.

10. The computer-implemented method of claim 1, wherein deploying the workload in the destination host computing system comprises:
initial placement of the workload on the destination host computing system;
placing the workload in the destination host computing system while powering on the workload on the destination host computing system;
placing the workload in the destination host computing system during migration of the workload from a source host computing system to the destination host computing system; or placing the workload on the destination host computing system during cloning of the workload.

11. The computer-implemented system of claim 1 wherein the plurality of data blocks relating to the workload is an open virtualization format (OVF) package or open virtualization appliance (OVA) file that packages the workload for deployment.

12. A management server comprising:
a processor; and
a memory coupled to the processor, the memory comprising a deployment module to:
receive a request to deploy a workload on a destination host computing system;
in response to receiving the request, retrieve a digest file corresponding to the workload from a storage device, the digest file including a plurality of hash values with each hash value corresponding to a data block of a plurality of data blocks associated with a virtual disk stored in the storage device;
determine whether the plurality of hash values in the digest file match with data in a content based read cache (CBRC) of the destination host computing system;
transmit data blocks corresponding to hash values that are not present in the CBRC from the storage device to the destination host computing system; and
initiate deployment of the workload on the destination host computing system in response to transmitting the data blocks corresponding to the hash values that are not present in the CBRC.

13. The management server of claim 12, wherein the deployment module is to:
for each hash value:
responsive to a determination that a hash value in the digest file does not exists in the CBRC of the destination host computing system, transmit a data block corresponding to the hash value from the storage device to the destination host computing system; and
responsive to a determination that the hash value in the digest file exists in the CBRC of the destination host computing system, mark the data block corresponding to the hash value as available and refrain from transmitting the data block corresponding to the hash value to the destination host computing system.

14. The management server of claim 12, wherein the storage device is an open virtualization format (OVF) repository locally accessible to the destination host computing system or remotely accessible to the destination host computing system via a uniform resource locator (URL).

15. The management server of claim 12, further comprising:
a digest file generation module to:
divide the virtual disk into the plurality of data blocks having an n-word block size;
determine a hash value corresponding to each data block using a secure hash algorithm (SHA); and
generate the digest file including mapping of each data block to the corresponding hash value.

16. The management server of claim 12, wherein the workload comprises a virtual machine, a virtual appliance, or a virtual application.

17. A non-transitory computer-readable storage medium storing instructions that, when executed by a processor of a destination host computing system, causes the processor to:
receive a request to deploy a workload on the destination host computing system;
in response to receiving the request, retrieve a digest file associated with a virtualized computing instance file corresponding to a virtual disk of the workload, the digest file comprising a plurality of hash values with each hash value corresponding to a data block of a plurality of data blocks in the virtualized computing instance file;
determine whether the plurality of hash values in the digest file match with data in a content based read cache (CBRC) of the destination host computing system;
request data blocks corresponding to hash values that does not exist in the CBRC from the storage device; and
deploy the workload on the destination host computing system upon receiving the data blocks corresponding to the hash values that does not exist in the CBRC.

18. The non-transitory computer-readable storage medium of claim 17, wherein instructions to request the data blocks corresponding to the hash values that does not exist in the CBRC comprise instructions to:
for each hash value:
responsive to a determination that a hash value in the digest file does not exists in the CBRC at the destination host computing system, obtain a data block corresponding to the hash value from the storage device; and
responsive to a determination that the hash value in the digest file exists in the CBRC of the destination host computing system, mark the data block corresponding to the hash value as available and refrain from transmitting the data block corresponding to the hash value to the destination host computing system.

19. The non-transitory computer-readable storage medium of claim 17, wherein instructions to deploy the workload on the destination host computing system comprise instructions to:
migrate or clone the workload running on a source host computing system to the destination host computing system, wherein the digest file comprises the hash values of the CBRC of the source host computing system when the request is to migrate or clone the workload.

20. The non-transitory computer-readable storage medium of claim 17, wherein the plurality of data blocks relating to the workload is an open virtualization format (OVF) package or open virtualization appliance (OVA) file that packages the workload for deployment.
